(19) United States
(12) Patent Application Publication
(10) Pub. No.: US 2018/0183686 A1
(43) Pub. Date: Jun. 28, 2018

(54) NETWORK MANAGEMENT INFRASTRUCTURE

(71) Applicant: THOMPSON Licensing, Issy-les-Moulineaux (FR)

(72) Inventors: Guillaume BICHOT, La Chapelle Chaussee (FR); Ludovic HAVET, Liffré (FR); Stephane GOUACHE, CLESSON SEVIGNE (FR)

(21) Appl. No.: 15/578,769

(22) PCT Filed: May 26, 2016
(86) PCT No.: PCT/EP2016/061931

§ 371 Date: Dec. 1, 2017

(30) Foreign Application Priority Data
Jun. 1, 2015 (EP) 15305840.9

(51) Int. Cl. H04L 12/24; H04L 12/28

(52) U.S. Cl. CPC H04L 41/26; H04L 41/22; H04L 41/24; H04L 12/2898

(57) ABSTRACT

Network management infrastructure operable to be connected to at least one remote home network comprising at least one terminal (T21, T22) connected to a gateway (BRG2), wherein said infrastructure comprises a processor configured to connect a physical network interface (PNIB) of the infrastructure to the home network.

### TECHNICAL FIELD

The present disclosure generally relates to the field of networks.

More particularly, the disclosure deals with the provision of services to users in the context of the NFV (“Network Functions Virtualization”) paradigm.

Thus, the disclosure concerns a network management infrastructure and a method for troubleshooting a home network. It further concerns a computer program implementing the troubleshooting method of the disclosure.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

FIG. 1 shows an example of a conventional network architecture wherein NSPs (Network Service Providers) provide users internet access by installing in users premises broadband residential gateways.

In FIG. 1, two homes H1, H2 equipped with broadband residential gateways BRG1, BRG2 are represented. In each home, a LAN (Local Area Network) connnecting one or more terminals is deployed. Each broadband residential gateway BRG1, BRG2 is connected to the Internet through an access line L1, L2 and a server SP of the NSP.

In this conventional network architecture, a broadband residential gateway gathers a lot of network functions. Thus, it implements generally the follwing functions: DLNA (Digital Living Network Alliance) Server, DHCP (Dynamic Host Configuration Protocol), DNS (Domain Name System), NAT (Network Address Translation), firewall, UI (User Interface), router, switch, management interface.

Within this architecture, the subscription of a new network service by the user is often accompanied by the deployment of a software upgrade in the best case or of a new device in the worst case within the user premises. This results in a long and costly deployment for the NSP.

Furthermore, new and more advanced services require more complex devices to enable them. This also leads to increasing operational expenditure in service maintenance.

NFV is a solution that aims to reduce the deployment cost and the time to market of network services through virtualization, thereby allowing certain network functions to be moved from specialized hardware located on-site, in the home network, to general-purpose hardware possibly located in the network operator virtual infrastructure.

Virtual CPE is part of this so called NFV paradigm that is about executing network functions hosted by the residential home gateway onto commoditized hardware hosting a virtual machine infrastructure, e.g. private or public cloud infrastructure, instead of requiring specific on purpose hardware.

FIG. 2 shows an example of network architecture, within the NFV framework, implementing the virtual CPE concept.

In FIG. 2, two homes H1, H2 equipped with broadband residential gateways BRG1, BRG2 are represented. In each home, a LAN (Local Aread Network) connnecting one or more terminals is deployed. Each broadband residential gateway BRG1, BRG2 is connected to the Internet through an access line L1, L2 and a server infrastructure S of the service provider. The server infrastructure S comprises a plurality of apparatuses, i.e. physical machines, for instance, as represented in FIG. 2, two physical machines A1, A2.

In this network architecture, a broadband residential gateway is basically a simple bridge between the home LAN and the access line. Thus, it implements mainly an Ethernet switch function and a few network functions permitting, if the access line goes down, to cope with DNS and DHCP for supporting the connection of new devices to the home LAN.

In this architecture, most of the network functions are moved within the server infrastructure S which implements the NSP cloud infrastructure. Thus, the server infrastructure S plays here the role of a virtual gateway. In addition to the network functions, this virtual gateway hosts an entity for managing the virtual resources (virtual machines, storage and networking), an entity for managing and controlling, for each customer/subscriber, the VNFs (Virtual Network Functions) that compose the virtual CPE and a user interface for allowing an operator controlling and provisioning the virtual CPEs.

In the following disclosure, the server infrastructure S is also named virtual gateway or network management infrastructure.

Thus, by this virtualization approach, it is possible to reduce the cost and lead time associated with the deployment of layer 3 CPE devices (FIG. 1, e.g. a router) by replacing them with less complex and therefore less expensive layer 2 CPE devices (FIG. 2, e.g. a switch) in the user premises, while virtualizing and moving the layer 3 and above functions to the network operator infrastructure cloud (FIG. 2).

FIG. 3 shows a NSP user interface when adding a new subscriber, for instance in the home H1.

Once the user is provisioned by the NSP through an admin portal, the broadband residential gateway BRG1 can establish a tunnel with the virtual gateway S which provides indeed an extension of the LAN of the home H1 up to the virtual gateway and the NSP cloud infrastructure.

For the new subscriber, the default network functions that are activated are shown in FIG. 3. The customer can connect terminals behind its broadband residential gateway BRG1 as a laptop PC labelled T1 in FIG. 2. The terminal IP address is automatically configured through the DHCP protocol by the DHCP server residing in the virtual gateway S that allocates IP addresses according to the range provisioned by the NSP, as shown in FIG. 3.

The user has the possibility to interact with her/his virtual gateway through a dedicated user interface as it was already possible with a legacy broadband residential gateway. The FIG. 4 shows an example of such user interface wherein the user can see and change the range of IP addresses allocated to her/his home.

One problem with the architecture described above is related to troubleshooting. Indeed, existing hardware and software tools cannot easily be adapted under the form of a Virtualized Network Function (VNF) for being plugged as part of the virtual CPE of a particular subscriber's home.

### SUMMARY

The present disclosure proposes a solution for improving the situation.

Accordingly, the present disclosure provides a network management infrastructure operable to be connected to at least one remote home network comprising at least one terminal connected to a gateway, wherein said infrastructure comprises a processor configured to connect a physical network interface of the infrastructure to the home network.

According to an embodiment, the physical network interface belongs to one apparatus of the server infrastructure.

Advantageously, the processor is operable to associate the physical network interface of said one apparatus with a switch of the gateway of the home network.

Thus, any device connected to this physical network interface is automatically connected to the home network.

For instance, the device is a troubleshooting device.

The present disclosure also provides a method for troubleshooting a home network, comprising:
attaching a physical network interface of a remote network management infrastructure, comprising at least one apparatus, to the home network;
connecting a troubleshooting device to the physical network interface.

According to an embodiment, the physical network interface belongs to one apparatus of the server infrastructure.

Advantageously, the method comprises associating the physical network interface of said one apparatus with a switch of a gateway of the home network.

According to an embodiment, the home network is a Local Area Network, LAN.

The method according to the disclosure may be implemented in software on a programmable apparatus. It may be implemented solely in hardware or in software, or in a combination thereof.

Since the present disclosure can be implemented in software, the present disclosure can be embodied as computer readable code for provision to a programmable apparatus on any suitable carrier medium. A carrier medium may comprise a storage medium such as a floppy disk, a CD-ROM, a hard disk drive, a magnetic tape device or a solid state memory device and the like.

The disclosure thus provides a computer-readable program comprising computer-executable instructions to enable a computer to perform the method of the disclosure. The diagram of FIG. 7 illustrates an example of the general algorithm for such computer program.

### BRIEF DESCRIPTION OF THE DRAWINGS

The present disclosure is illustrated by way of examples, and not by way of limitation, in the figures of the accompanying drawings, in which like reference numerals refer to similar elements and in which:

FIG. 1, already described, is a schematic view of a conventional network architecture;

FIG. 2, already described, is a schematic view of a NFV network architecture wherein embodiments of the present disclosure are advantageously implemented;

FIG. 3, already described, shows an example of a NSP user interface when adding a new subscriber;

FIG. 4, already described, shows an example of a subscriber user interface;

FIG. 5 shows an example of a NSP user interface when attaching a troubleshooting port, according to an embodiment of the disclosure;

FIG. 6 is a schematic view illustrating the connection of a remote device to a home network, according to an embodiment of the disclosure; and

FIG. 7 is a flowchart showing the steps of the troubleshooting method according to an embodiment of the present disclosure.

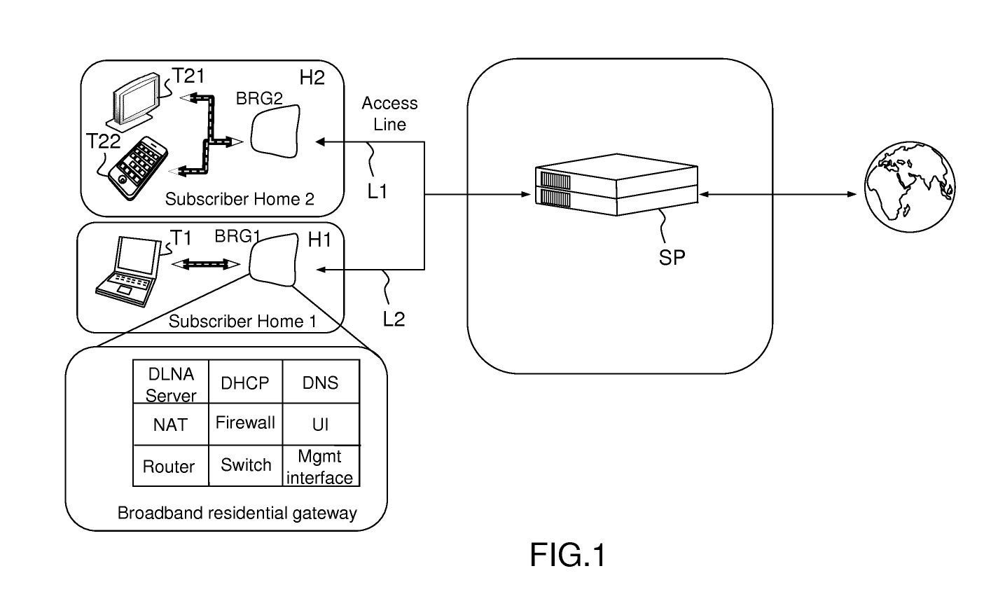

### DETAILED DESCRIPTION

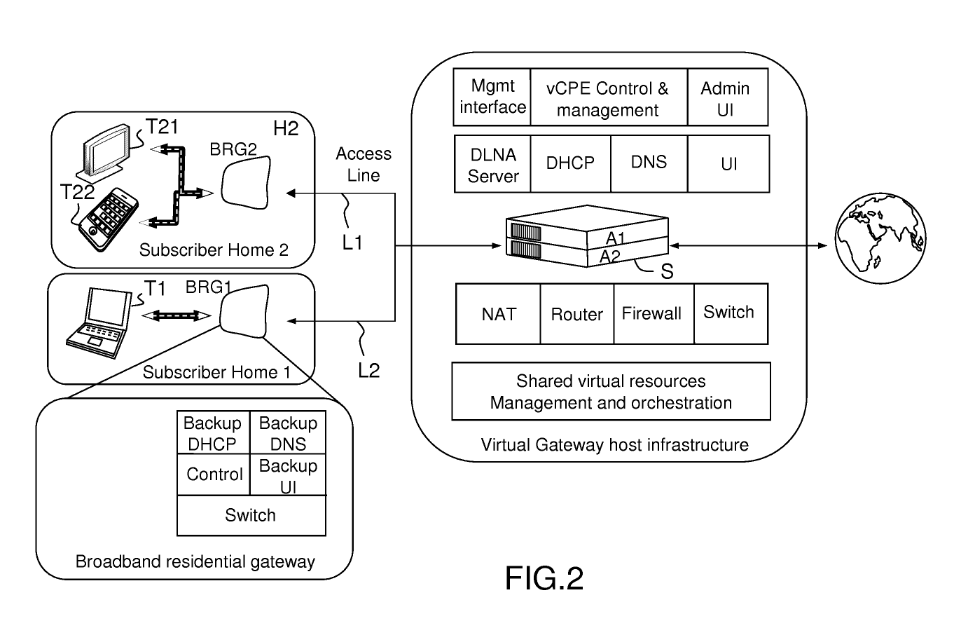

The embodiments of the present disclosure are implemented in a network system having the NFV architecture represented in FIG. 2.

According to an embodiment of the disclosure, a physical network interface, or port, of the virtual gateway S is attached to the LAN of the home H2.

Referring to FIG. 7, there is shown therein an example of a NSP user interface dedicated to the virtual CPE management. An operator can activate/associate, at step 100 (FIG. 7), a troubleshooting port with the subscriber's home LAN.

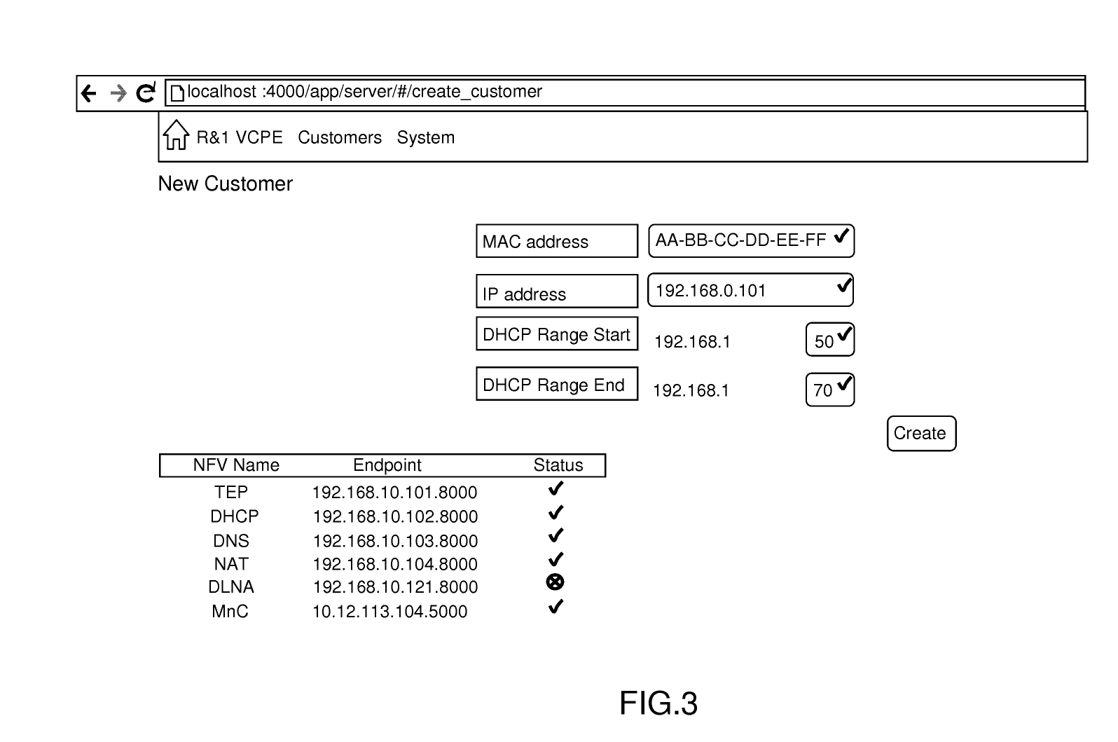

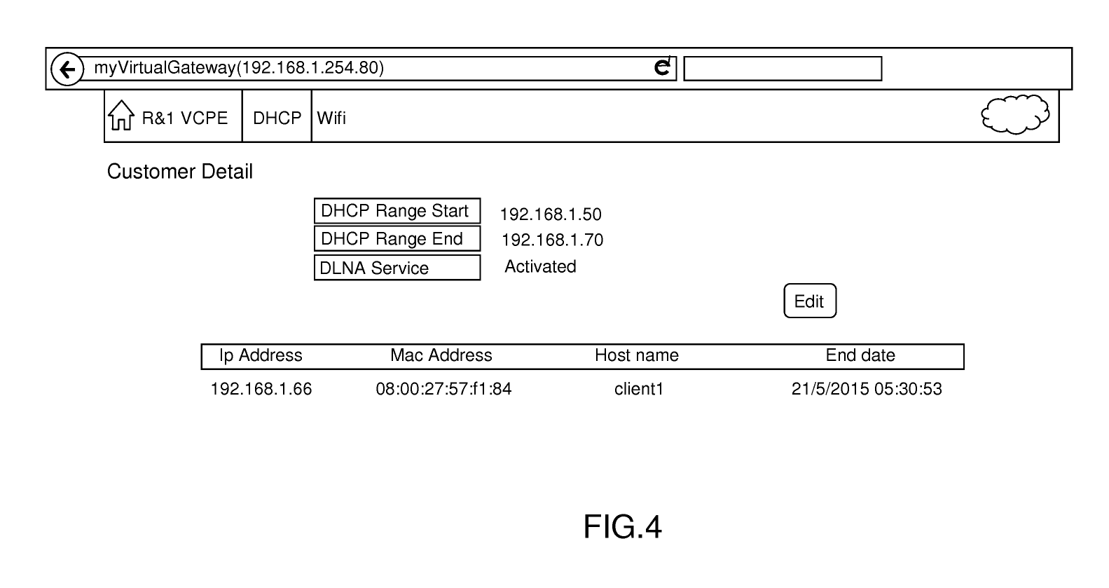

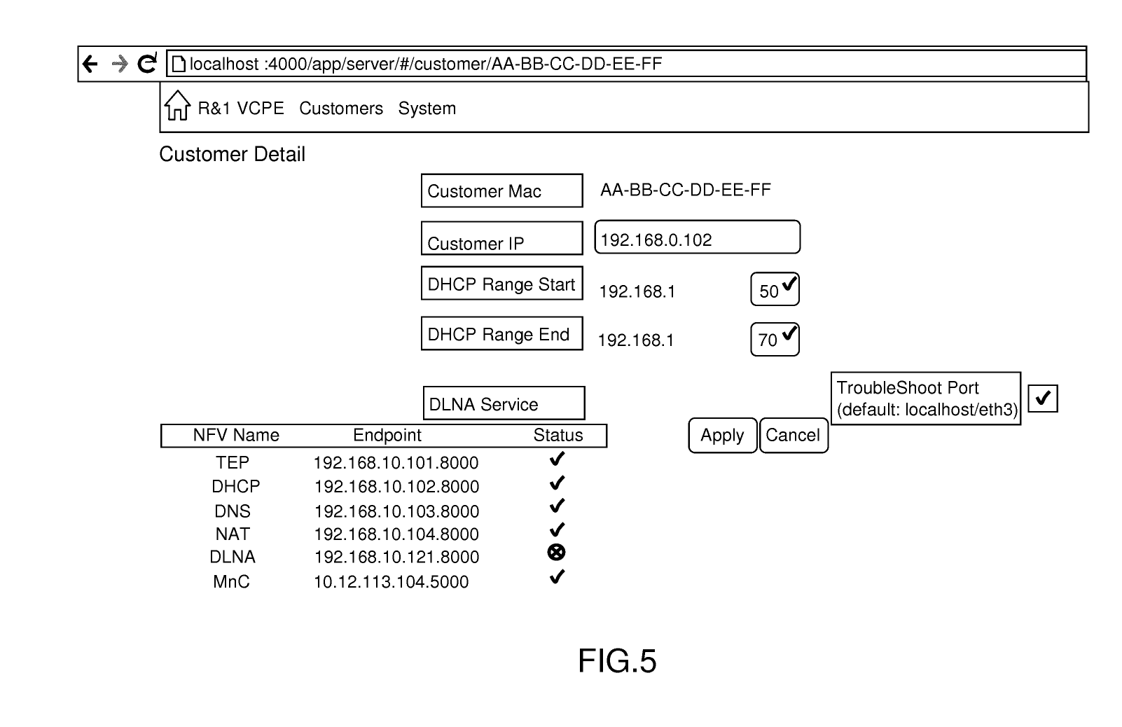

As it appears in FIG. 5, there is no DLNA service attached to the LAN of the home H2. It also appears that the IP address scheme is identical to the one of the LAN of the home H1 (FIG. 3) allowing overlapping addresses. This is not a problem despite sharing common network functions (like DHCP, NAT) as the latter operate a context and some resources dedicated to the subscriber.

Once the troubleshooting port is associated with the subscriber, then the LAN of the home H2 gets extended up to the devices connected to the troubleshooting port of the virtual gateway S. Thus a device D connected, at step 110, to the troubleshooting port in the virtual gateway S is virtually connected to the LAN of the home H2.

For instance, the device D is a troubleshooting console that will be used to facilitate the troubleshooting of the LAN of the home H2. The software of the device D can thus be launched easily and can access and control the subscriber terminals for troubleshooting.

An example of use is a connectivity problem between a TV and a tablet running a DLNA server in the LAN of the home H2. The NSP connects, at step 110, to the LAN of the home H2 a DLNA/UPnP analyzer D, which can act as a renderer, controller or yet a server for troubleshooting. The analyzer D carries out, at step 120, an analysis of the connectivity problem. The analyzer D first attempts to read the subscriber's content from his tablet successfully and then it sends the content to the TV. As it does not work, the console D streams to the TV a transcoded version of the content that gets displayed. The NSP informs then the subscriber that there is no connectivity problem but that the content format is not supported by his TV and that the DLNA controller he was using on his tablet does not work properly. The way the physical network interface of the virtual gateway S is associated with a particular home network depends on the virtualization implementation.

As explained earlier, once provisioned, a broadband residential gateway is connected with the server infrastructure S through a network tunnel, for example a Generic Routing Encapsulation (GRE) or a Virtual Extensible LAN (V×LAN). The tunnel endpoint in the server infrastructure S is a virtual Ethernet switch wherein virtual LANs interconnect the VNFs together with the tunnels and the physical network interfaces.

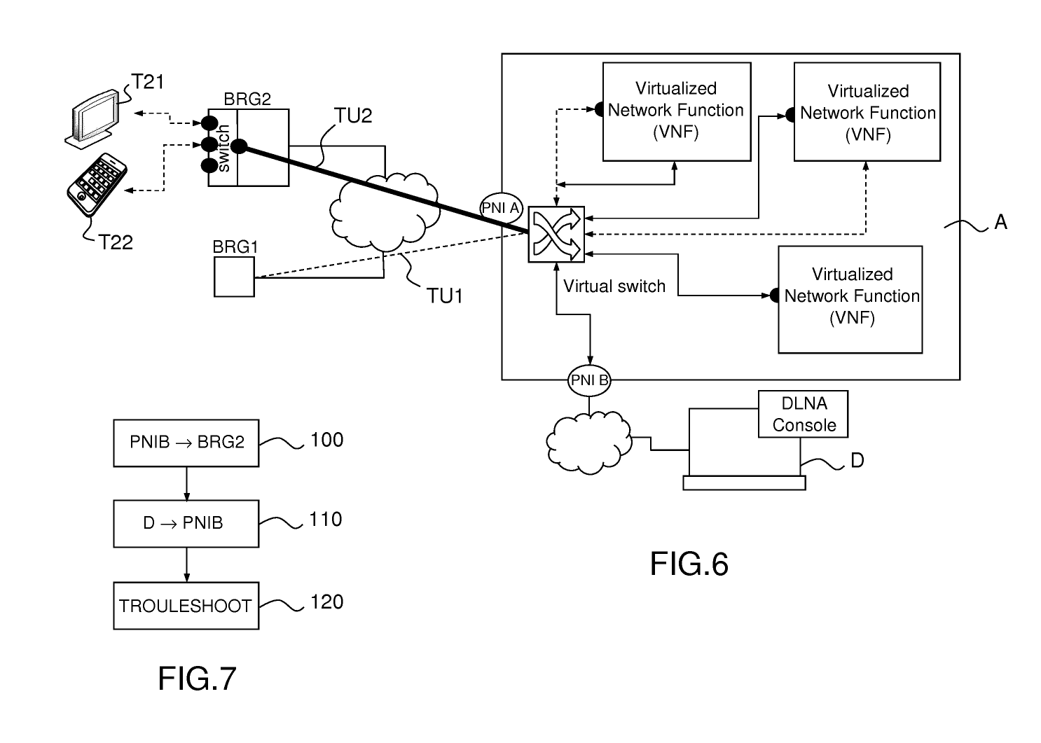

With reference to FIG. 6, the broadband residential gateway BRG2 associated with the home H2, interconnects, through its hosted Ethernet switch, home LAN terminals T21, T22 with a virtual switch hosted by an apparatus A of the server infrastructure S through a dedicated tunnel TU2.

Thanks to the administrator user interface, as represented in FIG. 5, a physical network interface PNIB of the apparatus A has been virtually connected to the switch of the broadband residential gateway BRG2. Thus, traffic to/from the broadband residential gateway BRG2 is forwarded from/to the physical network interface PNIB through the virtual switch.

In the example represented in FIG. 6, three VNFs are attached to the broadband residential gateway BRG2 (continuous lines) whereas two VNFs are also attached to the broadband residential gateway BRG1 (dotted lines) associated with the home H1 through a dedicated tunnel TU1. A VNF can be multi-tenant so as it functions to be shared among several subscribers home networks.

While there has been illustrated and described what are presently considered to be the preferred embodiments of the present disclosure, it will be understood by those skilled in the art that various other modifications may be made, and equivalents may be substituted, without departing from the true scope of the present disclosure. Additionally, many modifications may be made to adapt a particular situation to the teachings of the present disclosure without departing from the central inventive concept described herein. Furthermore, an embodiment of the present disclosure may not include all of the features described above. Therefore, it is intended that the present disclosure is not limited to the particular embodiments disclosed, but that the disclosure includes all embodiments falling within the scope of the appended claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

A person skilled in the art will readily appreciate that various parameters disclosed in the description may be modified and that various embodiments disclosed and/or claimed may be combined without departing from the scope of the disclosure.

1-8. (canceled)

9. A network management infrastructure operable to be connected to at least one remote home network comprising at least one terminal configured to be connected to a gateway, wherein said infrastructure comprises a processor configured to connect a physical network interface of the infrastructure to the home network.

10. The network management infrastructure of claim 1, wherein the physical network interface belongs to one apparatus of the server infrastructure.

11. The network management infrastructure of claim 2, wherein the processor is configured to associate the physical network interface of said one apparatus with a switch of the gateway of the home network.

12. A method for troubleshooting a home network, comprising:
attaching a physical network interface of a remote network management infrastructure, comprising at least one apparatus, to the home network;
connecting a troubleshooting device to the physical network interface.

13. The method of claim 4, wherein the physical network interface belongs to one apparatus of the server infrastructure.

14. The method of claim 5, comprising associating the physical network interface of said one apparatus with a switch of a gateway of the home network.

15. The method of claim 4, wherein the home network is a Local Area Network, LAN.

16. A computer-readable program comprising computer-executable instructions to enable a computer to perform a method for troubleshooting a home network, comprising:
attaching a physical network interface of a remote network management infrastructure, comprising at least one apparatus, to the home network;
connecting a troubleshooting device to the physical network interface.
